(19) United States
(12) Patent Application Publication
(10) Pub. No.: US 2020/0332477 A1
(43) Pub. Date: Oct. 22, 2020

(54) HEAT MANAGEMENT FOR SYNTHETIC FIELDS AND ATHLETIC SURFACES

(71) Applicant: Seymour Tomarin, Dalton, GA (US)

(72) Inventor: Seymour Tomarin, Dalton, GA (US)

(21) Appl. No.: 16/762,558

(22) PCT Filed: Nov. 9, 2018
(86) PCT No.: PCT/US2018/059933

§ 371 Date: May 8, 2020

Related U.S. Application Data
(60) Provisional application No. 62/583,652, filed on Nov. 9, 2017.

(51) Int. Cl. E01C 13/08; F24F 6/04; B32B 5/06; B32B 5/24

(52) U.S. Cl. CPC E01C 13/08; F24F 6/043; B32B 2307/728; B32B 5/24; B32B 5/06

(57) ABSTRACT

Various embodiments for a drip irrigation system configured to control a temperature of at least a portion of a synthetic playing field are described. A system may include a synthetic surface and a drip irrigation system that provides water to one or more portions of the synthetic surface. The drip irrigation tubes include water outlets positioned relative to the synthetic surface such that synthetic fibers wick moisture from the water outlets. A pump may be fluidly coupled to plurality of irrigation tubes and a controller may be configured to cause the pump to drive fluid through the irrigation tubes at a controlled rate to provide heat management in at least a portion of the synthetic surface.

### CROSS-REFERENCE TO RELATED APPLICATION

This application claims the benefit of and priority to U.S. Provisional Patent Application No. 62/583,652 entitled “HEAT MANAGEMENT FOR SYNTHETIC FIELDS AND ATHLETIC SURFACES,” filed Nov. 9, 2017, the contents of which being incorporated by reference in their entirety herein.

### BACKGROUND

Synthetic surfaces, sometimes referred to as synthetic turf or artificial turf, can replace grass to lower maintenance costs associated with playing fields, lawns, playgrounds, and similar areas. While there are many advantages to synthetic surfaces, one drawback is that, due to the materials of its formulation, a synthetic surface can get much hotter than a natural surface when heated by the sun.

### BRIEF SUMMARY OF THE INVENTION

According to various embodiments, a network of drip irrigation tubing, or other similar type of irrigation tubing, may be installed between rows of fiber of a synthetic turf, for instance, above a primary backing of the synthetic turf, where water or other fluid is provided at a controlled or predetermined rate to maximize cooling of the synthetic turf, or portions thereof. The drip irrigation tubing may be positioned in a space between fibers, referred to as channels, where the space is formed when a synthetic turf is manufactured or tufted. Water or other fluid may be provided at such a rate that a moisture level in the fibers is maintained without oversaturating the fibers, thereby providing constant cooling of the synthetic surface.

According to one or more embodiments, a system is described having a synthetic surface comprising synthetic fibers; drip irrigation tubes positioned relative to the synthetic fibers (e.g., at least partially below the synthetic fibers), where the drip irrigation tubes include water outlets; a pump fluidly coupled to the irrigation tubes; and a controller configured to cause the pump to drive fluid through the irrigation tubes at a controlled rate to provide heat management in at least a portion of the synthetic surface, wherein at least a portion of the synthetic fibers are hydrophilic such that the synthetic fibers wick the fluid as it is expelled from the water outlets.

Infill material 118 may be positioned on top of the drip irrigation tubes and in between the fibers. In some embodiments, the infill 118 material may include wherein the infill material comprises: rubber, ethylene-propylene-diene (EPDM) rubber, sand, cork, mulch, coconut shell, thermoplastic elastomer (TPE), textured fibbers, thatch fibers 106, or a combination thereof.

The channels may be formed during a tufting, weaving, knitting, or other process, for instance, during a manufacturing of the synthetic surface. The synthetic surface may include a synthetic athletic field surface and the synthetic fibers may include a plurality of synthetic grass fibers. Additionally, the synthetic grass fibers may include face fibers having a first length; thatch fibers having a second length; and the drip irrigation tubes may be disposed in rows within the face fibers and the thatch fibers.

A width between the channels may be in a range of 3/16″ to ¾″ and a diameter of the irrigation tubes may be substantially similar to the width between the channels. The diameter of the irrigation tubes may be in a range of 3/16″ to ¾″. Further, the system may include a plurality of temperature sensors positioned throughout varying portions of the synthetic surface. The controller may be configured to determine a first temperature of a first portion of the synthetic surface based at least in part on a signal provided from a first one of the temperature sensors positioned in the first portion of the synthetic surface; determine a second temperature of a second portion of the synthetic surface based at least in part on a signal provided from a second one of the temperature sensors positioned in the second portion of the synthetic surface; and direct the fluid to the first portion of the synthetic surface to cool the first portion of the synthetic surface while abstaining from providing the fluid to the second portion of the synthetic surface.

According to one or more embodiments, a method is described comprising providing a synthetic surface comprising a plurality of synthetic fibers; positioning a drip irrigation system having a plurality of drip irrigation tubes near the synthetic fibers, the drip irrigation tubes comprising a plurality of water outlets; providing a pump fluidly coupled to the irrigation tubes; and directing, by a controller, the pump to drive fluid through the irrigation tubes at a controlled rate to provide heat management in at least a portion of the synthetic surface, wherein at least a portion of the synthetic fibers are hydrophilic such that the synthetic fibers wick the fluid as it is expelled from the water outlets.

In some embodiments, the method further comprises positioning infill material on top of the drip irrigation tubes and in between the fibers, the infill material comprising: rubber infill, sand infill, or a combination thereof; forming a plurality of channels during a tufting process during a manufacturing of the synthetic surface; and positioning the tubing in the channels during installation of the synthetic surface or the drip irrigation system. Additionally, the synthetic grass fibers may include face fibers having a first length; thatch fibers having a second length; and the drip irrigation tubes may be disposed in rows within the face fibers and the thatch fibers.

The method may further include positioning a plurality of temperature sensors throughout varying portions of the synthetic surface; determining a first temperature of a first portion of the synthetic surface based at least in part on a signal provided from a first one of the temperature sensors positioned in the first portion of the synthetic surface; determining a second temperature of a second portion of the synthetic surface based at least in part on a signal provided from a second one of the temperature sensors positioned in the second portion of the synthetic surface; and directing, by the controller, the fluid to the first portion of the synthetic surface to cool the first portion of the synthetic surface, for instance, while abstaining from providing the fluid to the second portion of the synthetic surface.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is an illustration of a cross-sectional view of a synthetic surface with drip irrigation according to various embodiments of the present disclosure.

FIG. 2 is an illustration of a drip irrigation system according to various embodiments of the present disclosure.

FIG. 3 is an illustration of a top view of a synthetic surface with drip irrigation according to various embodiments of the present disclosure.

FIG. 4 is an illustration of a synthetic fiber for use in a synthetic field that comprises a hydrophobic outer later and a hydrophobic inner layer.

### DETAILED DESCRIPTION

The present disclosure relates to heat management for synthetic fields and surfaces. Synthetic surfaces are often installed as playing fields for sports (e.g., football, soccer, baseball, or field hockey) or leisure surfacing (e.g., playgrounds or landscaping). The surface of synthetic fields can appear similar to grass, with various fiber length depending on the application. Frequently spanning a large area, a drawback is that the synthetic surface can get hot in the sun. The synthetic fibers of the surface may include polymers, such as polyethylene, polypropylene, nylon, and polyester, which retain heat and reach high temperatures from warm weather and sunlight, which can be a drawback to these synthetic surfaces.

Notably, sports fields and other surfaces that incorporate synthetic fibers and receive direct sunlight can get up to approximately 40-70 degrees hotter than surrounding air temperatures. For instance, on warmer days, synthetic turf fields can heat to temperatures from 120 to 180° Fahrenheit (48 to 82° Celsius). As a result, playing on synthetic turf having such high temperatures can result in melting shoes, blistered hands or feet, increased risk of dehydration or heatstroke, as well as damage to an artificial turf. Accordingly, the heat retention in synthetic surfaces is problematic.

Manufacturers attempt to solve the heat retention problem in synthetic surfaces by using copolymers for synthetic fibers, or including additives in the fiber composition. Alternatively, the infill may be composes of a material that retains less heat. For instance, infill materials having a lighter color or formed of organic materials have been used, such as shredded coconut shells.

In another example, installations have included an external watering spray system, configured similar to a traditional sprinkler system that allows watering the field before a game; however, the water evaporates quickly and benefit of the water cooling effect wears off quickly. In any event, the standard procedure today for cooling off a synthetic field includes spraying the field with water, which results in an inefficient usage of water and oversaturation of the synthetic surface. All of these attempts to reduce the temperature of the playing surface have had minimal effect.

Accordingly, various embodiments for a drip irrigation system are described herein to control a temperature of at least a portion of a synthetic surface (e.g., landscaping or athletic playing field) and maintain a suitable temperature for use thereof. As such, a supply of water or other fluid may be provided to synthetic turf fibers, where such fibers may include those configured to absorb and wick moisture in such a way to provide a passive and/or active cooling effect on the fiber and reduce a temperature of the fiber.

For instance, in various embodiments, a synthetic surface with drip irrigation may include a network of drip irrigation tubing. The drip irrigation tubing may be disposed at least partially below and/or in between the rows of fiber of the synthetic surface. In some embodiments, the drip irrigation tubing may be positioned above a primary backing of the synthetic surface. A synthetic surface, such as an artificial field, may be tufted or woven to create a space between the fibers that would allow the drip system to be placed over the field. The system may provide a regulated flow of water to maintain a moisture level in a range of suitable moisture levels in the fibers, thereby constantly cooling the field.

With a drip system, less water may be used as compared to a traditional sprinkler system that applies water to a top of a surface of the synthetic field, conserving water while maintaining a cool surface. In some embodiments, a rate at which water is provided through outlets of drip irrigation tubing is controlled to be substantially similar to a rate at which fibers of the synthetic surface are able to wick moisture without being oversaturated. Thus, the fibers of the synthetic surface may be continuously dampened while excess water is not added to the synthetic surface or playing field. As a result of the wicking of the moisture from the drip irrigation, passive evaporative cooling is achieved in combination with active cooling (e.g., cooling achieved by the application of water being cooler than a temperature of the synthetic turf).

Utilizing a drip system, the amount of water needed to feed the system is minimized while directing the flow and controlling the flow rate. Rather than having a flow of water like a regular hose that is dependent on the source water pressure, the water in a drip system is regulated by a controller system such that water comes out of water outlets positioned along the tubing as a drip. For example, to conserve water resources for food production in dry regions where water is a scarce commodity, a drip system may be configured with holes in tubing to allow for water to drip out at the individual plant location.

For a synthetic surface with drip irrigation, there may be a control system configured to control the flow of the water to drip at a constant rate or intermittently, as required. Additionally, the tubing may be configured to direct the drip irrigation. For example, the tubing of the drip system may be configured to have water outlets, or holes, spaced as to wet or moisturize the infill of the synthetic turf to cool the surface. In some embodiments, a water outlet or hole may be provided for each fiber (or bundle of fibers) in a row of a synthetic turf. Alternately, the tubing of the drip system may be configured to have holes spaced as to wet or moisturize the thatch used to stabilize the infill. In some examples, infill can be positioned on top of the tubing to provide a level playing surface while weighing the synthetic surface and the tubing down. The synthetic surface may be laid over an underlayment system to provide cushion and drainage. The synthetic surface can have holes in the synthetic turf to provide for drainage of any excess moisture from rain or caused by the drip irrigation system.

The synthetic surface system may include synthetic turf comprising synthetic fibers made from polymers, such as polyethylene, polypropylene, nylon, polyester, or other material as may be appreciated. In some examples, a face fiber composed of a soft and durable nylon fiber may be used. For example, as nylon holds water, the drip irrigation system can drip water to be absorbed by the nylon thatch and nylon face fiber, thereby cooling the fiber and reducing the temperature of the fibers and the field. In some examples, an infill may be included to cover the tubing of the drip system so that the player's shoes and cleats would not disturb or damage the tubing and the players would not trip on the tubing.

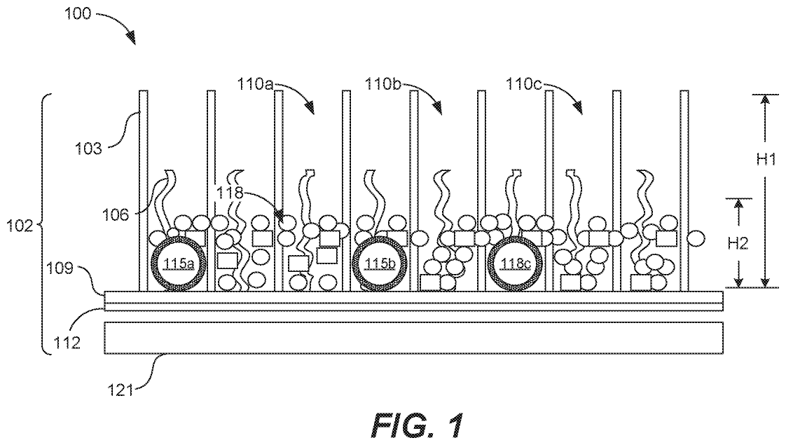

Turning to FIG. 1, illustrated is a cross-sectional view of a drip irrigation system 100 and a synthetic surface 102. The synthetic surface 102 may include a plurality of face fibers 103 of the same height, for example, arranged in rows that are substantially parallel, although other arrangements may be employed. Further, the synthetic surface 102 may include a plurality of thatch fibers 106 disposed between the face fibers 103, where the thatch fibers 106 support and stabilize the face fibers 103 or provide a fuller appearance of the synthetic surface 102. In some embodiments, the thatch fibers 106 may not be included in the synthetic surface 102 as they are generally optional. The face fibers 103 and the thatch fibers 106 may be tufted, knitted, or woven into a primary backing 109 of the synthetic surface 102. By virtue of the tufting, knitting, or weaving process, a plurality of channels 110a . . . 110d (collectively “channels 110”) may be formed between face fibers 103 (or other fibers).

In some embodiments, the synthetic surface 102 includes a secondary backing 112 in contact with the primary backing 109. The tubing 115a . . . 115d (collectively “tubing 115” or “irrigation tubes”) of the drip irrigation system 100 may be disposed within the face fibers 103 and the thatch fibers 106 (e.g., in the channels 110), for instance, to provide moisture to the bottom or other appropriate portion of the fibers 103 over the face of the synthetic surface 102. A layer of infill material 118 may be added to cover the tubing 115, as discussed in greater detail below. In some embodiments, apertures (not shown) may be aligned in the primary backing 109 and the secondary backing 112 to allow additional drainage. The synthetic surface with drip irrigation system 100 may be detachably installed on an underlayment 121 to allow additional cushion and drainage.

Notably, FIG. 1 shows the drip irrigating tubes 115 positioned in a plurality of channels 110, where the channels 110 may be formed during a tufting process, a knitting process, or a weaving process (e.g., during a manufacturing of the synthetic surface). However, in alternative embodiments, the drip irrigation tubes 115 may be positioned below the synthetic surface 102. For instance, in some embodiments, the synthetic surface 102 is porous and permits the fluid to be wicked by the synthetic fibers from the drip irrigation tubes 115 that are placed, for instance, below the surface. To this end, in some embodiments, the primary backing 109 and the secondary backing 112 are formed of a porous material that enables the fluid to be wicked by the synthetic fibers from the drip irrigation tubes 115 while also allowing fluid (e.g., rain) to be drained and/or reused in the drip irrigation system 100. In some embodiments, the primary backing 109 and the secondary backing 112 include holes or other apertures that permit the fluid to be wicked by the synthetic fibers from the drip irrigation tubes 115 while also allowing fluid to be drained and/or reused in the drip irrigation system 100.

A width of the channels 110 may vary, for example, depending on a type of the synthetic surface or a manufacturer of the surface. Generally, a width of the channel ranges from 3/16″ to ¾″, or other channel width. To this end, in various embodiments, a diameter of the tubing 115 may be substantially similar to the width of the channel while being less than the width of the channel, forming a slight interference fit. For example, assuming the width of the channel 110 were ¾″, the diameter of the tubing 115 may be 11/16″ or ⅝″. To this end, the diameter of the tubing 115 may be selected from a range of ⅛″ to 11/16″, or other appropriate width depending on the width of the channels 110.

Additionally, the synthetic grass fibers may include face fibers 103 having a first length; thatch fibers 106 having a second length; and the drip irrigation tubing 115 may be disposed in rows within the face fibers 103 and the thatch fibers 106.

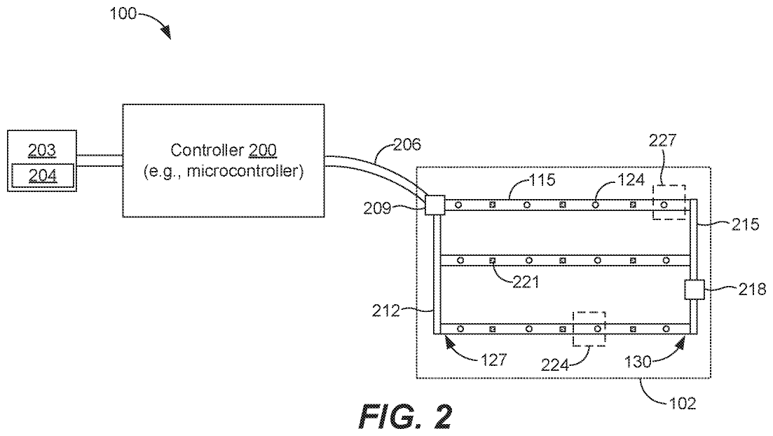

Shown in FIG. 2 is another example of the drip irrigation system 100. The drip irrigation system 100 may include a controller 200 (or a fluid regulator) that may include, for example, processing circuitry or other componentry configured to regulate an amount of water or other fluid introduced into the tubing 115 from a water source 203. The processing circuitry may include a microcontroller, in some examples, having program instructions stored in memory thereon that direct operation of a hardware processor, as well as other hardware or software thereon. In some embodiments, the processing circuitry can include a computing device having a hardware processor, memory, data bus, etc. The synthetic surface 102 may include, for instance, an athletic playing field, a lawn or other landscaping item, or other surface as may be appreciated.

The water inlet 206 may connect the tubing 115 to the controller 200 and water source 203 through a valve 209. A distributing tube 212 may be configured to provide a channel for the water to the drip tubing 115. The tubing 115 may include water outlets 124 sized and positioned for dispensing water at a predetermined rate as a function of the fibers 103 of the synthetic surface 102. In some embodiments, the water outlets 124 include a regulated drip irrigation emitter coupled to the water outlets 124, where the regulated drip irrigation emitter has a water outlet that controls a rate at which water drips or is otherwise expelled from the drip tubing 115. The regulated drip irrigation emitter may include an elastomeric membrane that regulates a rate at which water or other fluid is expelled from the drip tubing 115.

The tubing 115 may be positioned to form a network of tubing 115 positioned underneath a portion or an entirety of a synthetic turf field or other synthetic surface 102. In some examples, the drip irrigation system 100 may include additional valves positioned through the network of tubing 115 such that the controller 200 can direct water for cooling one portion of the field while abstaining from providing water to or cooling another portion of the field that may not require cooling.

In some embodiments, the specified rate at which water is produced from the tubing 115 may be modified based at least in part on the moisture wicking properties of the face fiber 103 (or other fiber or combination of materials of the synthetic field). Each tube of the tubing 115 may be connected, for instance, in a grid or other arrangement. Each tube of the tubing 115 may also include a first inlet end 127 connected to a distributing tube 212 and a second end 130 connected to an outlet tube 215. The outlet tube 215 may include a drainage valve 218 to expel water from the system. In some embodiments, water or other fluid drained from the system may be re-introduced in the drip irrigation system 100 to conserve water and improve the efficiency of the overall drip irrigation system 100.

Further, in some embodiments, the drip irrigation system 100 may include one or more temperature sensors 221 positioned in various portions of the network of tubing 115. For instance, in some embodiments, the controller 200 may be configured to obtain a temperature reading from each of the temperature sensors 221 to determine an approximate temperature of a region of the synthetic field or other surface. Based at least in part on the temperature, the controller 200 may be configured to direct water for cooling one portion of the field while abstaining from providing water to or cooling another portion of the field that may not require cooling.

The controller 200 may be configured to cause a pump 204 to drive fluid through the tubing 115 at a controlled rate to provide heat management in at least a portion of the synthetic surface 102. Additionally, in some embodiments, the controller 200 may determine a first temperature of a first portion 224 of the synthetic surface 102 based at least in part on a signal provided from a first one of the temperature sensors 221 positioned in or near the first portion 224 of the synthetic surface 102. Further, the controller 200 may determine a second temperature of a second portion 227 of the synthetic surface 102 based at least in part on a signal provided from a second one of the temperature sensors 221 positioned in the second portion 227 of the synthetic surface 102. The controller 200 may further direct the fluid to the first portion 224 of the synthetic surface 102 to cool the first portion 224 of the synthetic surface 102 while abstaining from providing the fluid to the second portion 227 of the synthetic surface 102 (e.g., as it is cooler it may not require cooling).

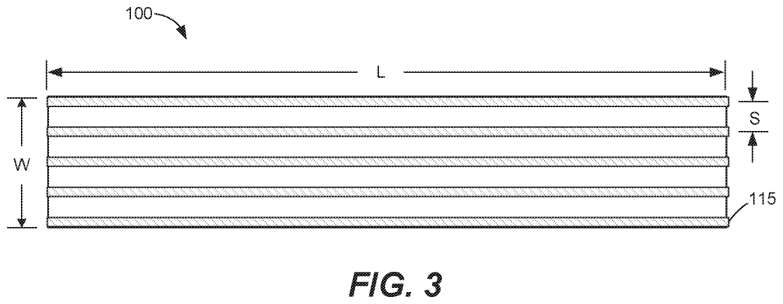

Next, FIG. 3 illustrates a synthetic surface 102 having the drip irrigation system 100 installed therein from a top view that has been rolled out for installation. The synthetic surface 102 with drip irrigation system 100 may be described as having a width (W) and a length (L), allowing the drip irrigation system 100 to be rolled up for quick installation on fields or other surfaces. To this end, in some embodiments, the tubing 115 of the drip irrigation system 100 may be formed of a flexible material (e.g., a flexible plastic or PVC). As such, the tubing 115 may include soaker tubing (also referred to as “soaker hoses”) in some embodiments. In some embodiments, the tubing 115 may eliminate a need to spray water the surface of the playing field which takes larger amounts of water and requires delivery systems, such as sprinklers or spray guns. It also makes the surface of a playing field overly wet. Also, by spraying the field, water tends to evaporate quickly and the fiber get hot again, which requires the field to be sprayed continuously during a game.

In some embodiments, the tubing 115 (e.g., the soaker tubing) can be placed either on top of the primary backing 109, for instance, between the rows of tufts of fiber. In some embodiments, the tubing 115 may be positioned below the surface in such a way to still allow water to reach the fiber and be wicked by the fiber 103 based on the hydrophilic characteristics of the fiber. Also, in some embodiments, the tubing 115 of the drip irrigation system 100 may be formed of a rigid material (e.g., a rigid plastic or PVC).

For example, assuming the drip irrigation system 100 were desired for a high school playing field, the width (W) may be 15 feet and the length (L) may be 160 feet, or other suitable dimensions. The synthetic surface 102 may be rolled out over multiple sections to cover the full area of the field. The tubing 115 is disposed in substantially parallel lengths (L) spaced in substantially even intervals. A first roll or section of the synthetic surface 102 with drip irrigation 100 may be connected to another roll or section, as may be appreciated. The second end 130 of the tubing may be connected to another section of synthetic surface 102, terminated in a closed system, or left open for drainage.

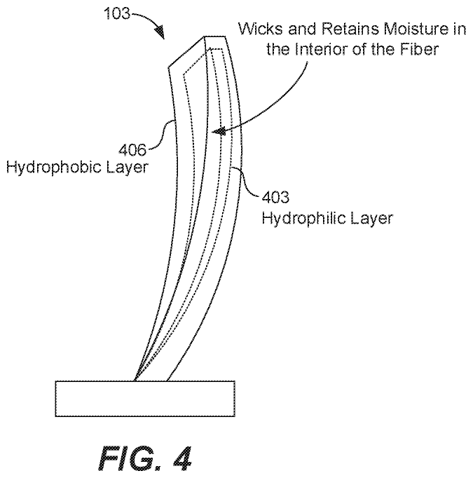

FIG. 4 illustrates an example embodiment of a face fiber 103 that may be employed in the synthetic surface 102. The face fiber 103 may include, for example, a hydrophilic inner layer 403 configured to wick moisture from the drip irrigation system 100 (or other fluid source). The face fiber 103 may also include a hydrophobic outer layer 406 configured to retain moisture in an interior of the face fiber 103 so that the face fiber 103 may maintain a longer duration of coolness. In additional embodiments, the face fiber 103 may include a coextruded fiber having a hydrophobic fiber material and a hydrophilic fiber material.

In some embodiments, the face fiber 103 may include heat and/or solar reflective properties. For instance, in some embodiments, an outer surface of the face fiber 103 may include a coating of a polymer or other material that causes the face fiber 103 to reflect heat and/or sunlight. Also, in some embodiments, an outer surface of the face fiber 103 may include a color that provides heat and/or reflective properties.

Thus, a system for heat management of a synthetic surface 102 may include, for example, a synthetic surface 102 comprising a plurality of channels 110, a plurality of drip irrigation tubes 115 positioned in the channels 110, the drip irrigation tubes 115 comprising water outlets 124, a pump 204 fluidly coupled to the irrigation tubes 115, and a controller 200 configured to cause the pump 204 to drive fluid through the irrigation tubes 115 at a controlled and/or predetermined rate to provide heat management to at least a portion of the synthetic surface 102. The synthetic surface 102 may include a plurality of fibers, such as face fibers 103 and/or thatch fibers 106.

In some embodiments, the fibers 103 are hydrophilic, being configured to wick moisture from the drip irrigation tubes. Infill material 118 may positioned on top of the drip irrigation tubes and in between the fibers, where the infill material 118 may include rubber infill, ethylene-propylene-diene (EPDM) rubber infill, sand infill, cork infill, mulch infill, coconut shell infill, thermoplastic elastomer (TPE) infill, textured fibbers, thatch fibers 106, or a combination thereof. The infill material 118 may act as a ballast to the synthetic surface 102 and/or include a grip material for players to maintain proper traction on the synthetic surface 102. In additional embodiments, the infill material 118 may include a material that holds moisture such as vermiculite. In some applications, the thatch fibers 106 may be used in place of an infill material 118. The channels 110 may be formed during a tufting, knitting, or weaving process (or other similar process), for instance, during a manufacturing of the synthetic surface 102.

The synthetic surface 102 may include a synthetic athletic field surface, where the synthetic surface 102 may include a plurality of face fibers 103 of a first length attached in rows to the first sheet in an orientation substantially normal to the first surface of the first sheet, a plurality of thatch fibers of a second length attached to the first sheet and disposed between the rows of the face fibers, a second sheet with a first surface, wherein the first surface of the second sheet is attached to a second surface of the first sheet. The drip irrigation tubes may be disposed in rows within the face fibers and the thatch fibers.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

1. A system, comprising:
a synthetic surface comprising a plurality of synthetic face fibers;
a plurality of drip irrigation tubes comprising a plurality of water outlets, the drip irrigation tubes positioned relative to the synthetic surface such that the synthetic face fibers wick moisture from the water outlets;
a pump fluidly coupled to the drip irrigation tubes; and
a controller configured to cause the pump to drive fluid through the drip irrigation tubes at a controlled rate to provide heat management in at least a portion of the synthetic surface, wherein at least a portion of the synthetic face fibers are hydrophilic such that the synthetic face fibers wick the fluid as it is expelled from the water outlets, thereby cooling at least the portion of the synthetic surface.

2. The system of claim 1, further comprising infill material positioned on top of the drip irrigation tubes and in between the synthetic fibers, the infill material comprising: rubber infill, ethylene-propylene-diene (EPDM) rubber infill, sand infill, cork infill, mulch infill, coconut shell infill, thermoplastic elastomer (TPE) infill, textured fibers, thatch fibers, or a combination thereof.

3. The system of claim 1, wherein the drip irrigation tubes are positioned
below the synthetic surface, wherein the synthetic surface is porous and permits the fluid to be wicked by the synthetic face fibers from the drip irrigation tubes.

4. (canceled)

5. The system of claim 1, further comprising a plurality of synthetic thatch fibers, wherein:
the plurality of synthetic face fibers have a first length;
the plurality of synthetic thatch fibers have a second length; and
the drip irrigation tubes are disposed in rows within the synthetic face fibers and synthetic thatch fibers.

6. (canceled)

7. The system of claim 1, further comprising a plurality of temperature sensors positioned throughout varying portions of the synthetic surface.

8. The system of claim 7, wherein the controller is configured to:
determine a first temperature of a first portion of the synthetic surface based at least in part on a signal provided from a first one of the temperature sensors positioned in the first portion of the synthetic surface;
determine a second temperature of a second portion of the synthetic surface based at least in part on a signal provided from a second one of the temperature sensors positioned in the second portion of the synthetic surface; and
direct the fluid to the first portion of the synthetic surface to cool the first portion of the synthetic surface while abstaining from providing the fluid to the second portion of the synthetic surface.

9. A method, comprising:
providing a synthetic surface comprising a plurality of synthetic face fibers;
providing a drip irrigation system having a plurality of drip irrigation tubes;
positioning the drip irrigation tubes having a plurality of water outlets relative to the synthetic surface such that the synthetic face fibers wick moisture from the water outlets;
providing a pump fluidly coupled to the drip irrigation tubes; and
directing, by a controller, the pump to drive fluid through the drip irrigation tubes at a controlled rate to provide heat management in at least a portion of the synthetic surface, wherein at least a portion of the synthetic face fibers are hydrophilic such that the synthetic face fibers wick the fluid as it is expelled from the water outlets.

10. The method of claim 9, further comprising positioning infill material on top of the drip irrigation tubes and in between the synthetic face fibers.

11. (canceled)

12. The method of claim 9, further comprising positioning the drip irrigation tubes
below the synthetic surface, wherein the synthetic surface is porous and permits the fluid to be wicked by the synthetic face fibers from the drip irrigation tubes.

13. The method of claim 9, further comprising a plurality of synthetic thatch fibers, wherein:
the plurality of synthetic face fibers have a first length;
the plurality of synthetic thatch fibers have a second length; and
the drip irrigation tubes are disposed in rows within the synthetic face fibers and the synthetic thatch fibers.

14. The method of claim 9, further comprising positioning a plurality of temperature sensors throughout varying portions of the synthetic surface.

15. The method of claim 14, further comprising:
determining a first temperature of a first portion of the synthetic surface based at least in part on a signal provided from a first one of the temperature sensors positioned in the first portion of the synthetic surface;
determining a second temperature of a second portion of the synthetic surface based at least in part on a signal provided from a second one of the temperature sensors positioned in the second portion of the synthetic surface; and
directing, by the controller, the fluid to the first portion of the synthetic surface to cool the first portion of the synthetic surface while abstaining from providing the fluid to the second portion of the synthetic surface.

16. The system of claim 1, wherein individual drip irrigation tubes of the plurality of drip irrigation tubes comprise a first end coupled to a distribution tube and a second end coupled to an outlet tube.

17. The system of claim 1, wherein the synthetic face fibers retain at least a portion of the fluid, thereby further cooling at least the portion of the synthetic surface.

18. The system of claim 1, wherein the plurality of synthetic face fibers comprise nylon.

19. The system of claim 1, wherein the synthetic surface comprises a synthetic athletic field surface or a synthetic landscaping surface and the synthetic fibers comprise a plurality of synthetic grass fibers.

20. The system of claim 3, wherein:
a width between the channels is in a range of 3/16″ to ¾″; and
the diameter of the irrigation tubes is in a range of 3/16″ to ¾″.

21. The method of claim 10, wherein the infill material comprises: rubber infill, ethylene-propylene-diene (EPDM) rubber infill, sand infill, cork infill, mulch infill, coconut shell infill, thermoplastic elastomer (TPE) infill, textured fibbers, thatch fibers, or a combination thereof.

22. The system of claim 1, wherein the drip irrigation tubes are positioned in a plurality of channels formed during a tufting process, a knitting process, or a weaving process,

23. The method of claim 9, further comprising positioning the drip irrigation tubes in a plurality of channels formed during a tufting process, a knitting process, or a weaving process.
